(19) United States
(12) Patent Application Publication
(10) Pub. No.: US 2025/0008258 A1
(43) Pub. Date: Jan. 2, 2025

(54) LOUDSPEAKER SYSTEM AND PASSIVE RADIATOR MODULE THEREOF

(71) Applicant: Eastech (Huizhou) Co., Ltd., Guangdong (CN)

(72) Inventors: QIAO-LIN REN, Guang Dong (CN); Kuo LIU, Guang Dong (CN); Da-Wen SHAO, Guang Dong (CN)

(21) Appl. No.: 18/757,519

(22) Filed: Jun. 28, 2024

(30) Foreign Application Priority Data
Jun. 29, 2023 (CN) 202321688894.9

(51) Int. Cl. H04R 1/28; H04R 1/02; H04R 7/04; H04R 7/18

(52) U.S. Cl. CPC H04R 1/2834; H04R 1/025; H04R 7/04; H04R 7/18

(57) ABSTRACT

A passive radiator module includes a cavity and two passive radiators, and the two passive radiators are disposed on an upper surface and a lower surface of the cavity respectively. Each of the two passive radiators includes a hang edge, a surrounding part and a diaphragm, the surrounding part surrounds the diaphragm, and the surrounding part is positioned between the hang edge and the diaphragm. Each of the upper surface and the lower surface includes a hollow part, the hang edge of any one of the two passive radiators is connected to a corresponding one of the upper surface and the lower surface, and the diaphragm of said any one of the two passive radiators is positioned in the hollow part of the corresponding one of the upper surface and the lower surface.

### RELATED APPLICATIONS

This application claims priority to China Patent Application No. 202321688894.9, filed Jun. 29, 2023, the entirety of which is herein incorporated by reference.

### BACKGROUND

### Field of Invention

The present invention relates to hardware architectures, and more particularly, a loudspeaker system and its passive radiator module.

### Description of Related Art

Music is an important product of human civilization. With the improvement of people's living standards, the types of music-related devices have become more and more diversified. Among them, the loudspeaker system is an important device that can effectively increase the sound volume. In addition to its application in music, users can also use the loudspeaker system to allow more listeners to hear the message that the user wants to publish.

The purpose of the passive radiator in the loudspeaker system is to enhance the bass and low-frequency penetration. However, the existing passive radiator only improves the bass by reducing its resonance frequency or increasing the radiation area. It has a large volume and space, and only improves the bass, and its function is relatively single.

### SUMMARY

In one or more various aspects, the present disclosure is directed to a loudspeaker system to solve the problems of the prior art.

One embodiment of the present disclosure is related to a passive radiator module, which includes a cavity and two passive radiators. The cavity includes an upper surface, a lower surface and at least one opening, and the at least one opening is positioned between the upper surface and the lower surface. The two passive radiators is disposed on the upper surface and the lower surface of the cavity respectively, each of the two passive radiators includes a hang edge, a surrounding part and a diaphragm, the surrounding part surrounds the diaphragm, and the surrounding part is positioned between the hang edge and the diaphragm. Each of the upper surface and the lower surface includes a hollow part, the hang edge of any one of the two passive radiators is connected to a corresponding one of the upper surface and the lower surface, and the diaphragm of said any one of the two passive radiators is positioned in the hollow part of the corresponding one of the upper surface and the lower surface.

In one embodiment of the present disclosure, a surface of the hang edge has at least one reinforcement rib.

In one embodiment of the present disclosure, an aspect ratio of the surrounding part is 1:1.

In one embodiment of the present disclosure, the at least one opening is a single opening, and the single opening is positioned on one side of the cavity.

In one embodiment of the present disclosure, the at least one opening is a pair of openings, and the pair of openings is symmetrically positioned on opposite sides of the cavity.

Another embodiment of the present disclosure is related to a loudspeaker system, which includes a loudspeaker cabinet, at least one speaker driver and a passive radiator module. The at least one speaker driver is disposed in the loudspeaker cabinet. The passive radiator module is disposed in the loudspeaker cabinet, the passive radiator module includes a cavity and two passive radiators, the cavity includes an upper surface, a lower surface and at least one opening, the at least one opening is positioned between the upper surface and the lower surface, the two passive radiators is disposed on the upper surface and the lower surface of the cavity respectively, each of the two passive radiators includes a hang edge, a surrounding part and a diaphragm, the surrounding part surrounds the diaphragm, and the surrounding part positioned between the hang edge and the diaphragm. Each of the upper surface and the lower surface includes a hollow part, the hang edge of any one of the two passive radiators is connected to a corresponding one of the upper surface and the lower surface, and the diaphragm of said any one of the two passive radiators is positioned in the hollow part of the corresponding one of the upper surface and the lower surface.

In one embodiment of the present disclosure, the passive radiator module is disposed across an intermediate region of the loudspeaker cabinet, the at least one opening is a pair of openings, and the pair of openings is symmetrically positioned on opposite sides of the cavity, a speaker driver includes two speaker drivers respectively disposed on opposite sides of the passive radiator module.

In one embodiment of the present disclosure, the at least one opening is a single opening, the single opening is positioned on one side of the cavity, the passive radiator module is horizontally disposed on an inner side of the loudspeaker cabinet, and the at least one speaker driver is disposed on another inner side of the loudspeaker cabinet.

In one embodiment of the present disclosure, a surface of the hang edge has at least one reinforcement rib.

In one embodiment of the present disclosure, an aspect ratio of the surrounding part is 1:1.

Technical advantages are generally achieved, by embodiments of the present disclosure. With the technical solution of the present disclosure, the passive radiator module of the present disclosure improves space utilization and improves low-frequency characteristics. The passive radiator module is assembled in a module form to reduce the loss of the complete machine and reduce the need for materials. The passive radiator module can be applied to an ultra-thin loudspeaker system.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a stereogram of a passive radiator module according to one embodiment of the present disclosure;

FIG. 2 is a three-dimensional perspective view of a loudspeaker system according to one embodiment of the present disclosure;

FIG. 3 is a schematic cross-sectional view of a loudspeaker system according to another embodiment of the present disclosure;

FIG. 4 is an equivalent circuit diagram of the loudspeaker system in FIG. 3; and

FIG. 5 is a three-dimensional perspective view of a loudspeaker system according to another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

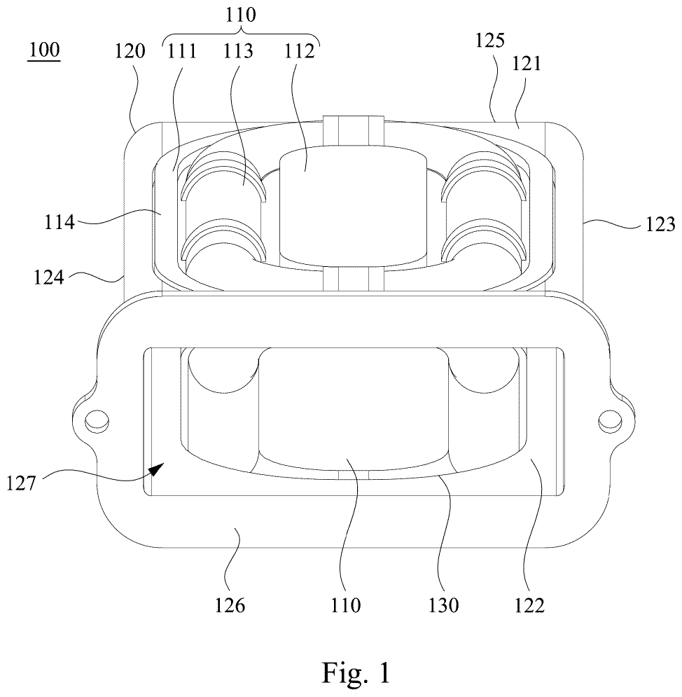

Referring to FIG. 1, in one aspect, the present disclosure is directed to a passive radiator module 100. This passive radiator module can be applied to various types of loudspeaker systems and may be applicable or readily adaptable to all technologies. Accordingly, the passive radiator module 100 has advantages. Herewith the passive radiator module 100 is described below with FIG. 1.

The subject disclosure provides t the passive radiator module 100 in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

FIG. 1 is a stereogram of the passive radiator module 100 according to one embodiment of the present disclosure. As shown in FIG. 1, the passive radiator module 100 includes a cavity 120 and two passive radiators 110. In structure, the cavity 120 includes an upper surface 121, a lower surface 122 and at least one opening 127, and the at least one opening 127 is positioned between the upper surface 121 and the lower surface 122. The two passive radiators 110 is disposed on the upper surface 121 and the lower surface 122 of the cavity 120 respectively, each of the two passive radiators 110 includes a hang edge 111, a surrounding part 113 and a diaphragm 112, the surrounding part 113 surrounds the diaphragm 112, and the surrounding part 113 is positioned between the hang edge 111 and the diaphragm 112. Each of the upper surface 121 and the lower surface 122 includes a hollow part 130, the hang edge 111 of any one of the two passive radiators 110 is connected to a corresponding one of the upper surface 121 and the lower surface 122, and the diaphragm 112 of said any one of the two passive radiators 110 is positioned in the hollow part 130 of the corresponding one of the upper surface 121 and the lower surface 122.

In some embodiments of the present disclosure, a surface of the hang edge 111 has at least one reinforcement rib 114. By increasing the height of the reinforcement ribs 114 on the hang edge 111, the forces on each portion of the surrounding part 113 are balanced.

In some embodiments of the present disclosure, the cross section of the surrounding part 113 may be at least partially U-shaped, but the present disclosure is not limited thereto. In another embodiment of the present disclosure, the surrounding part 113 may be annular structure, its cross-sectional shape of the structure can be annular, convex, concave, wavy, triangular, square, polygonal or a combination thereof, which can be used according to the design of the loudspeaker system.

In some embodiments of the present disclosure, an aspect ratio of the surrounding part 113 is 1:1, thereby increasing the linear amplitude. In practice, for example, the suspension system design of the passive radiator 110 is relatively special, and the aspect ratio of surrounding part 113 is 1:1, so that the linear amplitude can be as high as about 8 mm.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

In view of the above, the purpose of placing the two passive radiators 110 relative to each other is to balance the reaction force of the air load and to improve the rocking mode. In the case of compact structure of the complete machine, the design of the passive radiator module 100 can greatly improve the space utilization without losing the low frequency. The air convection phenomenon near the passive radiator 110 can assist a power amplifier or a digital signal processor (DSP) chip to dissipate heat, so that the power amplifier or the DSP chip can work more efficiently.

In some embodiments of the present disclosure, the at least one opening 127 of the cavity 120 of the passive radiator module 100 is a single opening, and the single opening is positioned on one side of the cavity 120. In practice, for example, as shown in FIG. 1, the lateral side 126 of cavity 120 has the opening 127, and the lateral sides 123, 124 and 125 of cavity 120 do not have opening. In other words, the opening 127 is the single opening of cavity 120.

Alternatively, in some embodiments of the present disclosure, the at least one opening of the cavity 120 of the passive radiator module 100 is a pair of openings, and the pair of openings is symmetrically positioned on opposite sides of the cavity 120. In practice, for example, the lateral side 126 of the cavity 120 has an opening 127, and the other lateral side 125 relative to the lateral side 126 can have another opening. In other words, the pair of openings is symmetrically positioned at the two opposite lateral sides 125 and 126 of the cavity 120.

Through the above-mentioned symmetrical single and double opening structures, the passive radiator module 100 can be applied to a variety of complete machine designs, and can be applied to ultra-thin loudspeaker systems.

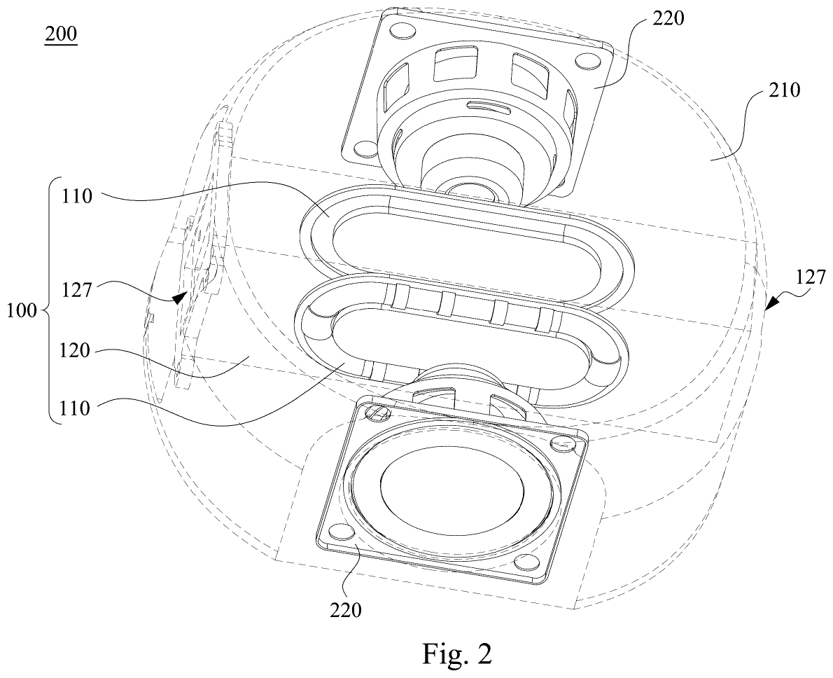

FIG. 2 is a three-dimensional perspective view of a loudspeaker system 200 according to one embodiment of the present disclosure. As shown in FIG. 2, the passive radiator module 100 in FIG. 1 is suitable for the loudspeaker system 200 in FIG. 2. In practice, for example, the loudspeaker system 200 can be used as an ultra-thin loudspeaker system, but the present disclosure is not limited thereto.

Referring to FIG. 1 and FIG. 2, the loudspeaker system 200 includes a loudspeaker cabinet 210, two speaker drivers 220 and the passive radiator module 100. The two speaker drivers 220 are disposed in the loudspeaker cabinet 210, and the passive radiator module 100 is disposed in the loudspeaker cabinet 210. The passive radiator module 100 includes a cavity 120 and two passive radiators 110. In structure, the cavity 120 includes an upper surface 121, a lower surface 122 and at least one opening 127, and the at least one opening 127 is positioned between the upper surface 121 and the lower surface 122. The two passive radiators 110 is disposed on the upper surface 121 and the lower surface 122 of the cavity 120 respectively, each of the two passive radiators 110 includes a hang edge 111, a surrounding part 113 and a diaphragm 112, the surrounding part 113 surrounds the diaphragm 112, and the surrounding part 113 is positioned between the hang edge 111 and the diaphragm 112. Each of the upper surface 121 and the lower surface 122 includes a hollow part 130, the hang edge 111 of any one of the two passive radiators 110 is connected to a corresponding one of the upper surface 121 and the lower surface 122, and the diaphragm 112 of said any one of the two passive radiators 110 is positioned in the hollow part 130 of the corresponding one of the upper surface 121 and the lower surface 122. Therefore, as shown in FIG. 2, the two passive radiators 110 are placed opposite each other to balance the reaction force of the air load and improve the rocking mode. The air convection phenomenon near the pairs of opening 127 can assist the power amplifier or the DSP chip to dissipate heat, so that the power amplifier or the DSP chip can work more efficiently.

As shown in FIG. 2, in some embodiments of the present disclosure, the passive radiator module 100 is disposed across an intermediate region of the loudspeaker cabinet 210, the above-mentioned at least one opening 127 is a pair of openings 127, and the pair of openings 127 are symmetrically positioned on opposite sides of the cavity 120, the two speaker drivers 220 disposed on opposite sides of the passive radiator module 100 respectively. In this way, while the loudspeaker system 200 has a compact structure, the design of the passive radiator module 100 can greatly improve the space utilization without losing the low frequency.

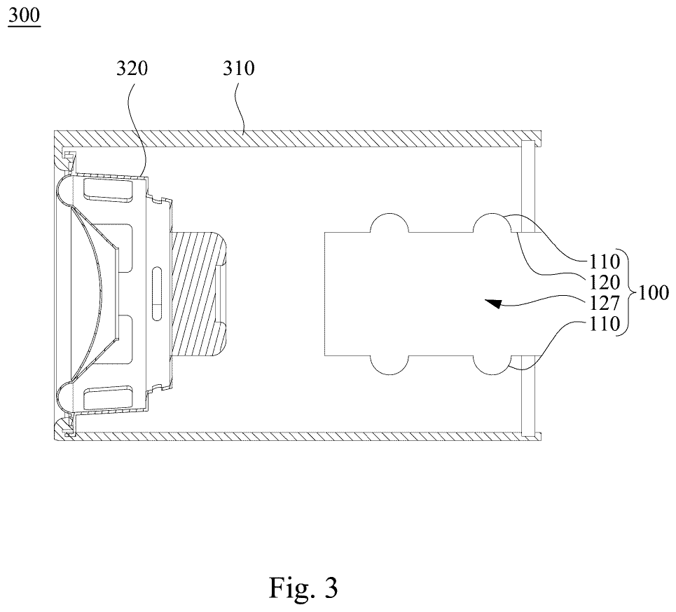

FIG. 3 is a schematic cross-sectional view of a loudspeaker system 300 according to another embodiment of the present disclosure. As shown in FIG. 3, the passive radiator module 100 in FIG. 1 is suitable for the loudspeaker system 300 in FIG. 3.

Referring to FIG. 1 and FIG. 3, the loudspeaker system 300 includes a loudspeaker cabinet 310, a speaker driver 320 and the passive radiator module 100. The speaker driver 320 is disposed in the loudspeaker cabinet 310, and the passive radiator module 100 is disposed in the loudspeaker cabinet 310. The passive radiator module 100 includes a cavity 120 and two passive radiators 110. In structure, the cavity 120 includes an upper surface 121, a lower surface 122 and at least one opening 127, and the at least one opening 127 is positioned between the upper surface 121 and the lower surface 122. The two passive radiators 110 is disposed on the upper surface 121 and the lower surface 122 of the cavity 120 respectively, each of the two passive radiators 110 includes a hang edge 111, a surrounding part 113 and a diaphragm 112, the surrounding part 113 surrounds the diaphragm 112, and the surrounding part 113 is positioned between the hang edge 111 and the diaphragm 112. Each of the upper surface 121 and the lower surface 122 includes a hollow part 130, the hang edge 111 of any one of the two passive radiators 110 is connected to a corresponding one of the upper surface 121 and the lower surface 122, and the diaphragm 112 of said any one of the two passive radiators 110 is positioned in the hollow part 130 of the corresponding one of the upper surface 121 and the lower surface 122. Therefore, as shown in FIG. 3, the two passive radiators 110 are placed opposite each other to balance the reaction force of the air load and improve the rocking mode.

As shown in FIG. 3, in some embodiments of the present disclosure, the at least one opening 127 is a single opening, the single opening is positioned on one side of the cavity 120, the passive radiator module 100 is horizontally disposed on an inner side of the loudspeaker cabinet 310, and the speaker driver 320 is disposed on another inner side of the loudspeaker cabinet 310. In practice, for example, the loudspeaker system 300 can be used as an ultra-thin loudspeaker system, but the present disclosure is not limited thereto.

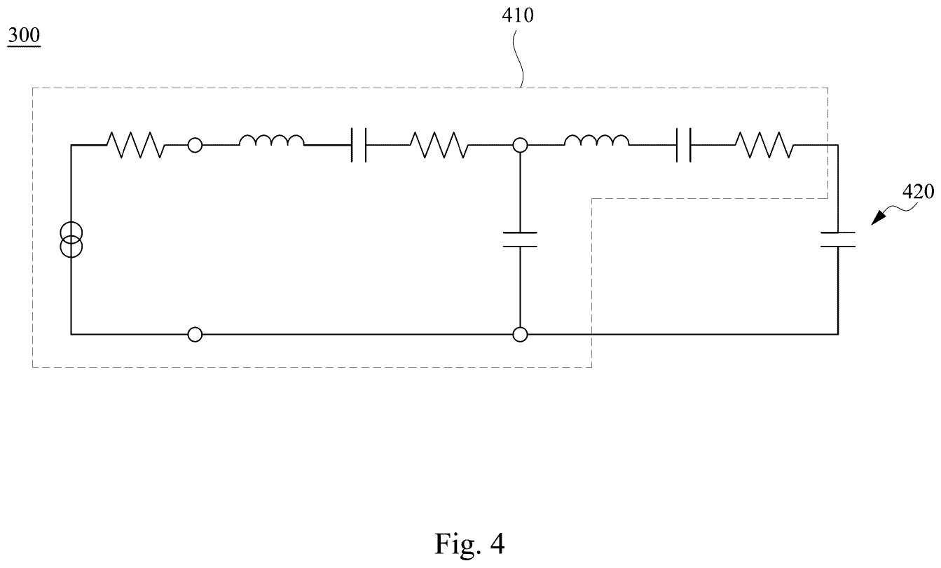

FIG. 4 is an equivalent circuit diagram of the loudspeaker system in FIG. 3. The equivalent circuit 410 of the speaker driver 320 is electrically coupled to the equivalent load 420 formed by the passive radiator module 100. With the equivalent load 420 formed by the passive radiator module 100, the loudspeaker system 300 has a large linear amplitude and slow low-frequency roll-off. The loudspeaker system 300 can be small in size and have good penetration. The passive radiator module 100 improves space utilization and improves low-frequency characteristics.

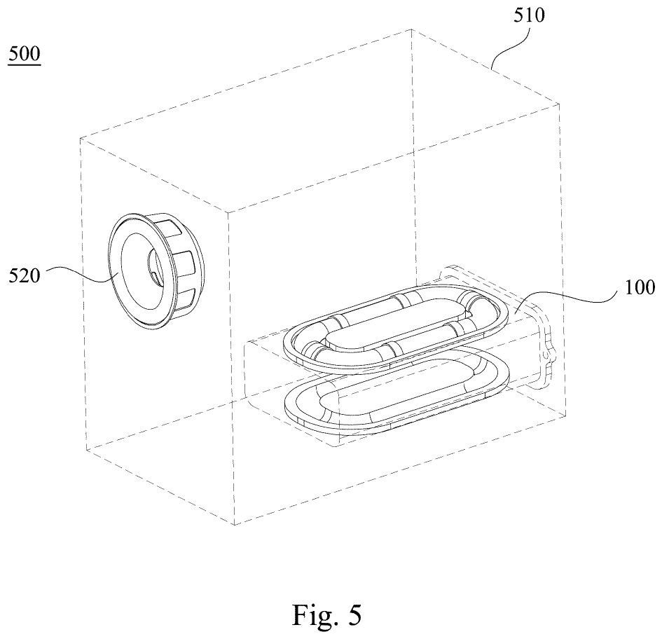

FIG. 5 is a three-dimensional perspective view of a loudspeaker system 500 according to another embodiment of the present disclosure. As shown in FIG. 5, the passive radiator module 100 in FIG. 1 is suitable for the loudspeaker system 500 in FIG. 5.

Referring to FIG. 1 and FIG. 5, the loudspeaker system 500 includes a loudspeaker cabinet 510, a speaker driver 520 and the passive radiator module 100. The speaker driver 520 is disposed in the loudspeaker cabinet 510, and the passive radiator module 100 is disposed in the loudspeaker cabinet 510. The passive radiator module 100 includes a cavity 120 and two passive radiators 110. In structure, the cavity 120 includes an upper surface 121, a lower surface 122 and at least one opening 127, and the at least one opening 127 is positioned between the upper surface 121 and the lower surface 122. The two passive radiators 110 is disposed on the upper surface 121 and the lower surface 122 of the cavity 120 respectively, each of the two passive radiators 110 includes a hang edge 111, a surrounding part 113 and a diaphragm 112, the surrounding part 113 surrounds the diaphragm 112, and the surrounding part 113 is positioned between the hang edge 111 and the diaphragm 112. Each of the upper surface 121 and the lower surface 122 includes a hollow part 130, the hang edge 111 of any one of the two passive radiators 110 is connected to a corresponding one of the upper surface 121 and the lower surface 122, and the diaphragm 112 of said any one of the two passive radiators 110 is positioned in the hollow part 130 of the corresponding one of the upper surface 121 and the lower surface 122.

In view of the above, technical advantages are generally achieved, by embodiments of the present disclosure. With the technical solution of the present disclosure, the passive radiator module 100 of the present disclosure improves space utilization and improves low-frequency characteristics. The passive radiator module 100 is assembled in a module form to reduce the loss of the complete machine and reduce the need for materials. The passive radiator module 100 can be applied to an ultra-thin loudspeaker system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A passive radiator module, comprising:
a cavity comprising an upper surface, a lower surface and at least one opening, and the at least one opening positioned between the upper surface and the lower surface; and
two passive radiators disposed on the upper surface and the lower surface of the cavity respectively, each of the two passive radiators comprising a hang edge, a surrounding part and a diaphragm, the surrounding part surrounding the diaphragm, and the surrounding part positioned between the hang edge and the diaphragm, wherein each of the upper surface and the lower surface comprises a hollow part, the hang edge of any one of the two passive radiators is connected to a corresponding one of the upper surface and the lower surface, and the diaphragm of said any one of the two passive radiators is positioned in the hollow part of the corresponding one of the upper surface and the lower surface.

2. The passive radiator module of claim 1, wherein a surface of the hang edge has at least one reinforcement rib.

3. The passive radiator module of claim 2, wherein an aspect ratio of the surrounding part is 1:1.

4. The passive radiator module of claim 3, wherein the at least one opening is a single opening, and the single opening is positioned on one side of the cavity.

5. The passive radiator module of claim 1, wherein the at least one opening is a pair of openings, and the pair of openings is symmetrically positioned on opposite sides of the cavity.

6. A loudspeaker system, comprising:
a loudspeaker cabinet;
at least one speaker driver disposed in the loudspeaker cabinet; and
a passive radiator module disposed in the loudspeaker cabinet, the passive radiator module comprising a cavity and two passive radiators, the cavity comprising an upper surface, a lower surface and at least one opening, the at least one opening positioned between the upper surface and the lower surface, the two passive radiators disposed on the upper surface and the lower surface of the cavity respectively, each of the two passive radiators comprising a hang edge, a surrounding part and a diaphragm, the surrounding part surrounding the diaphragm, and the surrounding part positioned between the hang edge and the diaphragm, wherein each of the upper surface and the lower surface comprises a hollow part, the hang edge of any one of the two passive radiators is connected to a corresponding one of the upper surface and the lower surface, and the diaphragm of said any one of the two passive radiators is positioned in the hollow part of the corresponding one of the upper surface and the lower surface.

7. The loudspeaker system of claim 6, wherein the passive radiator module is disposed across an intermediate region of the loudspeaker cabinet, the at least one opening is a pair of openings, and the pair of openings is symmetrically positioned on opposite sides of the cavity, the at least one speaker driver comprises two speaker drivers respectively disposed on opposite sides of the passive radiator module.

8. The loudspeaker system of claim 6, wherein the at least one opening is a single opening, the single opening is positioned on one side of the cavity, the passive radiator module is horizontally disposed on an inner side of the loudspeaker cabinet, and the at least one speaker driver is disposed on another inner side of the loudspeaker cabinet.

9. The loudspeaker system of claim 6, wherein a surface of the hang edge has at least one reinforcement rib.

10. The loudspeaker system of claim 6, wherein an aspect ratio of the surrounding part is 1:1.

11. A loudspeaker system, comprising:
a loudspeaker cabinet;
at least one speaker driver disposed in the loudspeaker cabinet; and
a passive radiator module disposed in the loudspeaker cabinet, the passive radiator module comprising a cavity and two passive radiators, the cavity comprising an upper surface and a lower surface, the two passive radiators disposed on the upper surface and the lower surface of the cavity respectively, each of the two passive radiators comprising a hang edge, a surrounding part and a diaphragm, the surrounding part surrounding the diaphragm, and the surrounding part positioned between the hang edge and the diaphragm, wherein each of the upper surface and the lower surface comprises a hollow part, the hang edge of any one of the two passive radiators is connected to a corresponding one of the upper surface and the lower surface, and the diaphragm of said any one of the two passive radiators is positioned in the hollow part of the corresponding one of the upper surface and the lower surface.

12. The loudspeaker system of claim 11, wherein the cavity further comprises a single opening, and the single opening is positioned on one side of the cavity.

13. The loudspeaker system of claim 12, wherein the passive radiator module is horizontally disposed on an inner side of the loudspeaker cabinet, and the at least one speaker driver is disposed on another inner side of the loudspeaker cabinet.

14. The loudspeaker system of claim 11, wherein the cavity further comprises a pair of openings, and the pair of openings is symmetrically positioned on opposite sides of the cavity.

15. The loudspeaker system of claim 14, wherein the at least one speaker driver comprises two speaker drivers respectively disposed on opposite sides of the passive radiator module.
